(19) United States
(12) Patent Application Publication
(10) Pub. No.: US 2025/0054404 A1
(43) Pub. Date: Feb. 13, 2025

(54) NON-COGNITIVE INSTRUMENT AND METHOD FOR PREDICTING STUDENT SUCCESS

(71) Applicant: Morgan State University, Baltimore, MD (US)

(72) Inventors: Carrol Perrino, Silver Spring, MD (US); Cheryl Rollins, Upper Marlboro, MD (US); Janine Jackson, Bowie, MD (US); Taj Rollins, Upper Marlboro, MD (US); Avis Jackson, Baltimore, MD (US)

(21) Appl. No.: 18/670,920

(22) Filed: May 22, 2024

Related U.S. Application Data
(63) Continuation of application No. 17/736,639, filed on May 4, 2022, now abandoned.
(60) Provisional application No. 63/183,834, filed on May 4, 2021.

(51) Int. Cl. G09B 7/00

(52) U.S. Cl. CPC G09B 7/00

(57) ABSTRACT

A computer implemented method and system for predicting and improving minority student success in college, including a non-cognitive skills questionnaire, the answers to which are weighted and scored and compared to a database of college graduates and college dropouts to predict a student's likelihood of success at college. Non-cognitive skills improvement activities are recommended to improve student scores. A machine learning module continuously evaluates predictions versus outcomes and automatically adjusts weighting, scoring and predictions to improve predictions and reduce or eliminate bias.

### BACKGROUND OF THE INVENTION

### Field of the Invention

The present invention is a method to determine whether a student is a suitable candidate for admission to a school of higher education, as implemented through a non-cognitive instrument that reduces or eliminates biases associated with other tests and methods. This invention also acts as a predictor of retention and graduation rates and also can predict when interventions are needed to keep students on track towards a successful post-college career.

### Description of the Background

The use of knowledge-based and non-cognitive testing as “potential” indicators of future student performance is well-known. The use of AI/machine learning is gaining acceptance across a variety of industries, including the college admission process. AI algorithms and models are trained by discovering patterns in massive datasets larger than humans could sensibly process on their own. Unfortunately, notwithstanding their benefits, current AI/ML systems suffer from an inherent susceptibility to bias, for example, in the way that it is now known that many standardized tests, including the SAT, suffer from racial and socioeconomic bias. Such bias can be introduced into an AI/machine-learning system unintentionally or intentionally, via organizational bias (bias inherent in the data provided by a specific organization), data bias (bias due to incorrect sample data that do not reflect the whole data set), prejudicial bias (where a model is fed prejudicial knowledge), measurement bias (bias as a result of incorrect measurement), and/or intentional bias (the embedding of unjust or discriminatory rules in the AI/machine learning models). Whatever the source(s) of bias, current AI/machine learning algorithms fail to take into account the possibility of bias in the training data and therefore fail to detect and/or address patterns of bias in the training data and/or in new data, with the result that existing AI/ML-assisted student performance prediction systems serve to further perpetuate, systematize, and extend these biases. The present invention addresses these deficiencies.

### SUMMARY OF THE INVENTION

This invention for predicting college academic success is based on a survey instrument consisting of multiple constructs that gather information from the student before entering college and confirming its validity through other constructs after entering college, which can extend beyond the student's time in college. A feedback process will include weighting of constructs and will continue to provide refinements to this methodology and its individual elements. Furthermore, it will also suggest when student support is necessary to enable admission, retention, and graduation.

A measure that successfully predicts college academic success for minority students is presented here. The instrument presented here measures twelve constructs known to be highly predictive of minority student success in college. Eight constructs will be measured before entering college and four constructs will be measured after one semester of college and may be conducted on a regular basis to include post-college experience. The constructs are set forth below:
1. Entering College Noncognitive Constructs
   a. Intrapersonal
      i. Dogged Determination
         1. Goal Orientation/Motivation
         2. Behavioral Persistence
      ii. Self-Efficacy
         1. Academic
         2. Performance
      iii. Identity
         1. Student
         2. Racial/Ethnic/Cultural
         3. Spiritual
      iv. Critical Thinking
         1. Metacognition
         2. Cognitive Flexibility
         3. Planning/Time Management/Organization
   b. Interpersonal
      i. Support System
      ii. Communication Skills
      iii. Emotional Intelligence
      iv. Sense of Belonging
2. Continuing in College Noncognitive Constructs
   a. Interpersonal
      i. Support System
      ii. Communication Skills
      iii. Emotional Intelligence
      iv. Sense of Belonging

Questions posed under each of the constructs may vary in count from 10 to 20.

Weightings of each of the constructs and the individual elements within those constructs will be adjusted as part of a larger feedback and machine learning processes to gauge and improve scoring, weighting, predictions, and recommended remedial measures. The machine learning algorithms will be preferably tuned to detect, reduce, and eliminate (to the extent possible) biases in the queries and answer options, as well as in the scoring, weighting and prediction algorithms. Different statistical methods or algorithms may be applied to the analysis. As part of an ongoing data collection effort, assessors may carry out further iterations to reflect any new line of questions that will be posed to the student population.

The results of the survey instrument may indicate that student support services may be provided in order to enhance the probability of admission, retention, or graduation.

According to a first embodiment, the instrument is deployed for the minority student population, including African American and other minority students at an HBCU, or other institution and reflects their experiences. The instrument effectively diminishes the inequities in outcomes in higher education using the resources that minority students, including those at HBCUs bring to the table. It will facilitate entrance into multiple professional fields including STEM, communications, education, health, etc. According to further embodiments, the instrument will be deployed individually and/or collectively across student populations of all racial and economic demographics.

The definition of success will be extended to include entering career paths and/or graduate or professional school. Similarly, the instrument may be modified for minority middle school populations initially, and subsequently across all middle school populations, to identify students who would benefit from existing school and community programs to prepare for higher education.

Accordingly, there is presented according to the invention, a device to capture the data from students, preferably a remote computing device, such as a tablet, a laptop computer, a smartphone, or similarly configured readily portable computing device, configured for remote communication with software that is used for retaining and analyzing the data relating to the twelve constructs and their elements and producing results that may determine whether some action is required to keep the student on a successful career track.

### BRIEF DESCRIPTION OF THE DRAWINGS

The foregoing summary, as well as the following detailed description of the preferred invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 depicts a computing node used in a first embodiment of a system according to the present invention;

FIG. 2 depicts an embodiment of a computing environment (also called the “first embodiment system”) according to the present invention;

FIG. 3 depicts abstraction model layers used in the first embodiment system;

FIG. 4 is a flowchart showing a first embodiment method performed, at least in part, by the first embodiment system;

FIG. 5 is a block diagram view of a machine logic (e.g., software) portion of the first embodiment system; and

FIG. 6 depicts a profile environment of a second embodiments of a system according to the present invention.

### DETAILED DESCRIPTION OF THE INVENTION

### I. Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operations to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the present invention are capable of being implemented in conjunction with any type of computing environment now known or later developed.

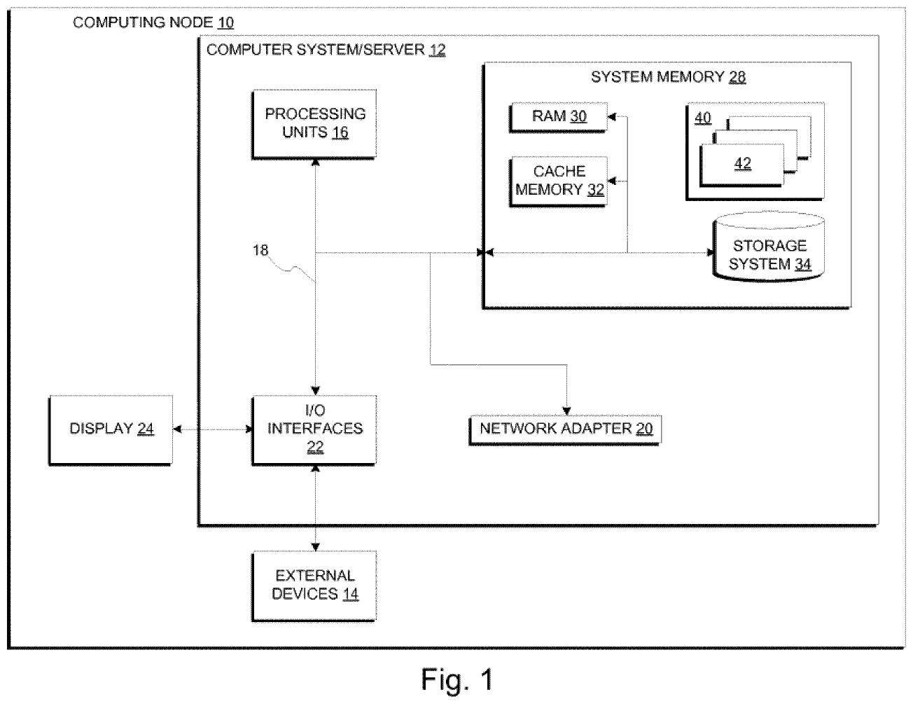

Referring now to FIG. 1, a schematic of an example of a computing node is shown. Computing node 10 is only one example of a suitable computing node and is not intended to suggest any limitation as to the scope of use or functionality of embodiments of the invention described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in computing node 10 is shown in the form of a general-purpose computing device. The components of computer system/server 12 may include, but are not limited to, processing units 16, a system memory 28, and a bus 18 that couples various system components including system memory 28 to processing units 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk, such as a CD-ROM, DVD-ROM or other optical media, can be provided. In such instances, each can be connected to bus 18 by one or more data media interfaces. As will be further depicted and described below, system memory 28 may include at least one program product having a set (e.g., at least one) of program modules that are configured to carry out the functions of embodiments of the invention.

Program/utility 40, having set of program modules 42, may be stored in system memory 28 by way of example, and not limitation, as well as an operating system, one or more application programs, other program modules, and program data. Each of the operating system, one or more application programs, other program modules, and program data or some combination thereof, may include an implementation of a networking environment. Set of program modules 42 generally carry out the functions and/or methodologies of embodiments of the invention as described herein.

Computer system/server 12 may also communicate with one or more external devices 14, such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks, such as a local area network (LAN), a general wide area network (WAN), and/or a public network (e.g., the Internet), via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

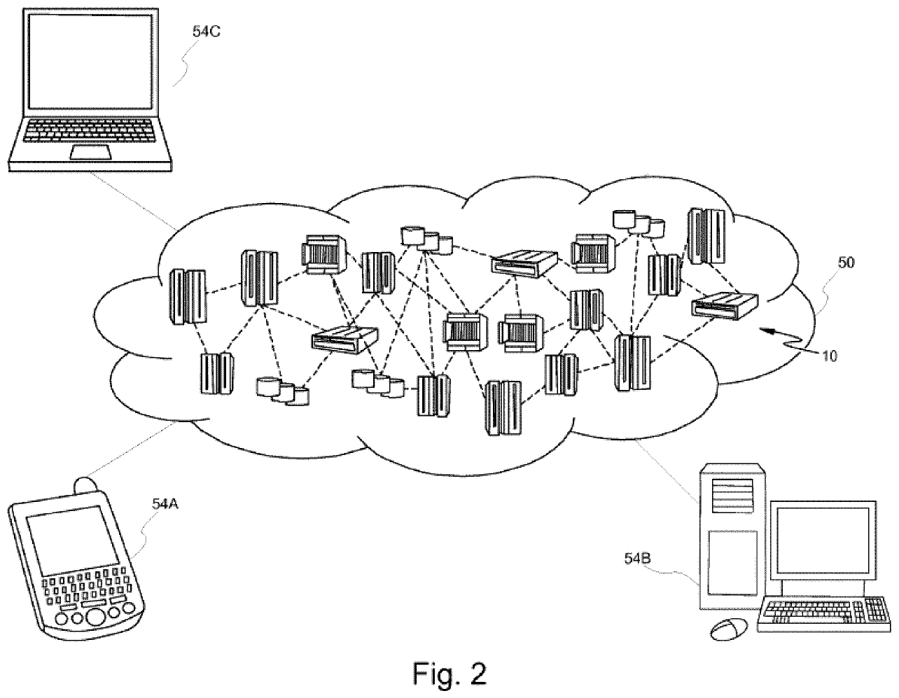

Referring now to FIG. 2, illustrative computing environment 50 is depicted. As shown, computing environment 50 comprises one or more computing nodes (e.g., computing node 10) with which local computing devices used by consumers, such as, for example, personal digital assistant (PDA) or cellular telephone 54A, desktop computer 54B, and/or laptop computer 54C may communicate. Computing nodes may communicate with one another. They may be grouped (not shown) physically or virtually, in one or more networks, such as Private, Community, Public, or Hybrid clouds as described hereinabove, or a combination thereof. This allows computing environment 50 to offer infrastructure, platforms and/or software as services for which a consumer does not need to maintain resources on a local computing device. It is understood that the types of computing devices 54A-C shown in FIG. 2 are intended to be illustrative only and that computing node 10 and computing environment 50 can communicate with any type of computerized device over any type of network and/or network addressable connection (e.g., using a web browser).

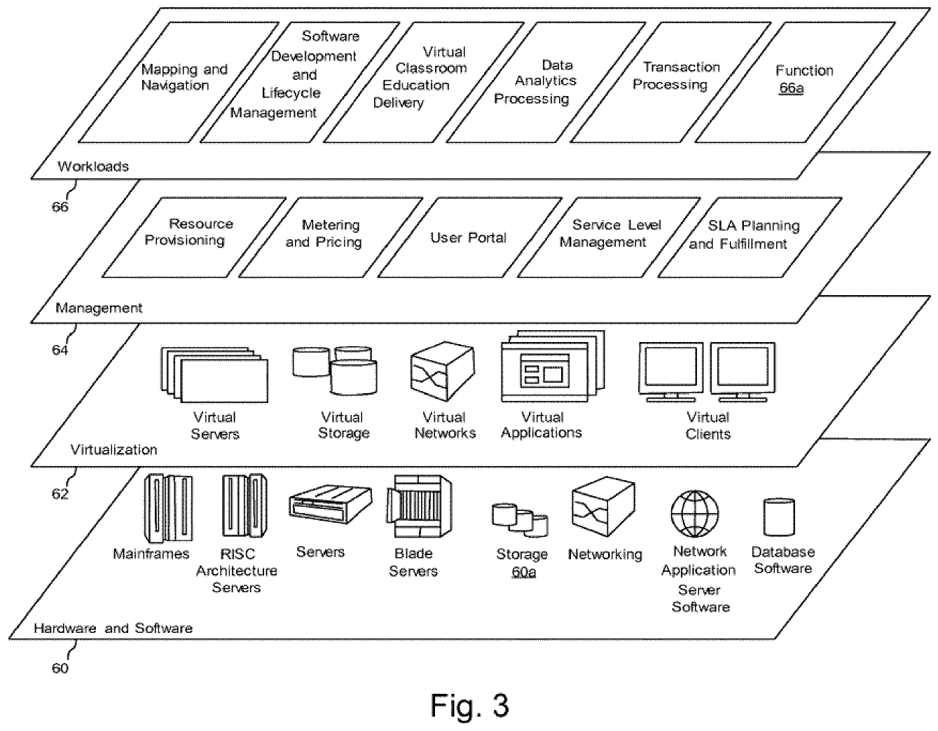

Referring now to FIG. 3, a set of functional abstraction layers provided by computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes; RISC (Reduced Instruction Set Computer) architecture-based servers; storage devices; database software; networks, and networking components. In some embodiments software components include network application server software.

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the computing environment for consumers and system administrators. Service level management provides cloud computing resource allocation and management such that required service levels are met. Service Level Agreement (SLA) planning and fulfillment provide pre-arrangement for, and procurement of, computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and functionality according to the present invention (see function block 66 a) as will be discussed in detail, below, in the following sub-sections of this Detailed description section.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

### II. Example Embodiment

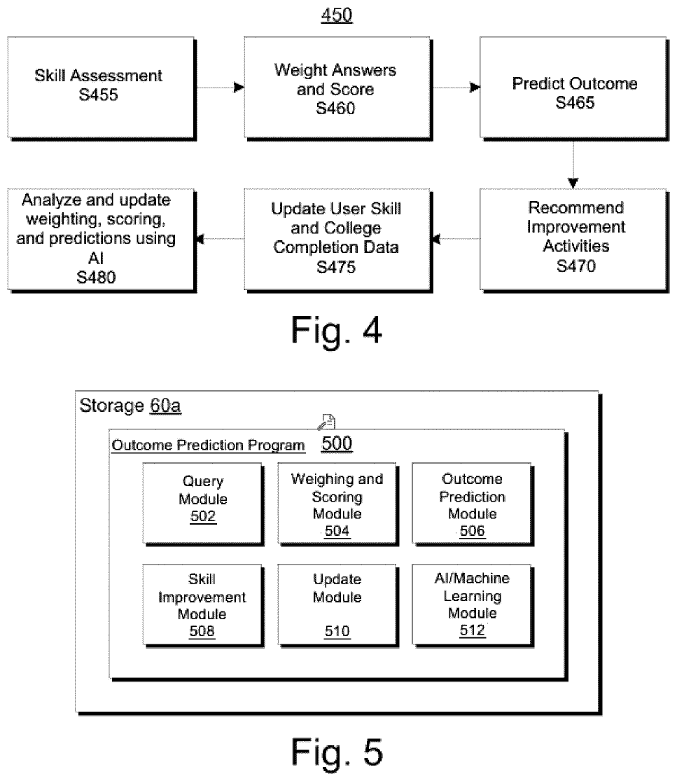

FIG. 4 shows flowchart 450 depicting a method according to the present invention. FIG. 5 shows college outcome prediction program 500, which performs at least some of the method operations of flowchart 450. This method will now be discussed, over the course of the following paragraphs, with extensive reference to FIG. 4 (for the method operation blocks) and FIG. 5 (for the software blocks). One physical location where college outcome prediction program 500 of FIG. 5 may be stored is in storage 60a (see FIG. 3). In this example, a user is preparing to apply for colleges and seeks to improve her chances of being accepted to her college of choice as well as her chances of succeeding. The colleges to which she will be applying would like to have a reliable tool for assessing her likelihood of success. Additionally, both the user and the colleges would like to have means for maximizing the user's success at college which means are specifically directed to the areas where the user might benefit from improvement. The user consults computer system/server 12 (FIG. 1), possibly at the recommendation of college, high school or middle school counselor, or even on her own, for an assessment and recommendations to maximize her chances of admittance to and success at college (and beyond).

Processing begins at operation S455, where query module 502 asks a series of questions to make an assessment of the user's non-cognitive skills. Specifically, query module 502 establishes a baseline non-cognitive skill profile for User by presenting to the user a series of questions directed to the following non-cognitive constructs:
1. Entering College Noncognitive Constructs
   a. Intrapersonal
      i. Dogged Determination
         1. Goal Orientation/Motivation
         2. Behavioral Persistence
      ii. Self-Efficacy
         1. Academic
         2. Performance
      iii. Identity
         1. Student
         2. Racial/Ethnic/Cultural
         3. Spiritual
      iv. Critical Thinking
         1. Metacognition
         2. Cognitive Flexibility
         3. Planning/Time Management/Organization
   b. Interpersonal
      i. Support System
      ii. Communication Skills
      iii. Emotional Intelligence
      iv. Sense of Belonging

For each construct, the user is presented with a series of questions addressing the particular construct, and the user is prompted to answer each question. According to one embodiment, the question and answer options may be in Likert format, in which the user is prompted to answer on a scale generally reflecting the range from Strongly Agree to Strongly Disagree. The answers can be textual as in the “agree or disagree” example or numeric, where, for example, 1 represents Strongly Disagree and 5 represents Strongly Agree. According to another embodiment, the question and answer options may be in ipsative question format in which the user is presented with several equally attractive behavioral statements from which the user has to choose one statement that is ‘most’ like them and/or one that is ‘least’ like them. Other probative non-cognitive question/answer formats are also considered to be within the scope of the invention.

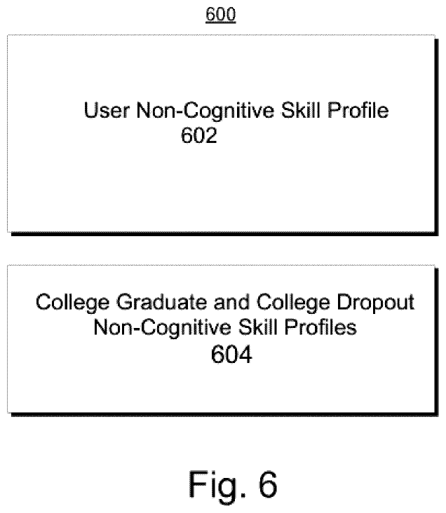

Query module 502 stores answers in user non-cognitive skill profile 602 (FIG. 6). Processing proceeds to operation S460, where weighting and scoring module 504 calculates a score for the User based on the answers stored in the non-cognitive skill profile and the construct weights that are stored in weighting module. Processing proceeds to operation S465, where prediction module 506 determines user's likelihood of successful completion of a college curriculum, preferably based on college graduate and college dropout non-cognitive skill profile 604 scores. In this example, prediction module 506 might determine that the user has a 75% chance of successfully completing a college curriculum. Prediction module 506 might also determine that the user's chance of successfully completing a college curriculum would increase if her non-cognitive skill score could be increased by a certain amount.

Processing proceeds to operation S470, where skill improvement module 508 recommends a one or more non-cognitive skill improvement activities to the user. In this example, skill improvement module 508 looks to user skill profile 602 and to college graduate and college dropout skill profiles 604 to determine the non-cognitive skills which the user must improve to improve her chances at successfully completing a college curriculum. In some embodiments of the present invention, skill improvement module 508 maintains a set of activities directed to improving different non-cognitive skills and projected increases in non-cognitive skills a user can achieve by carrying out the activities.

Processing proceeds to operation S475, in some embodiments of the present invention, where a period of time has passed and/or a prior user has complete one or more activities identified by skill improvement module 508, and update module 510 identifies a user as a prior user and accesses the user's non-cognitive skill profile. If the user has not yet entered college, but a predetermined time period has transpired since the user's last non-cognitive skill assessment and/or the user has completed one or more activities identified by skill improvement module 508, the update module 510 will access query module to conduct a further assessment, and the update module 510 will update the user's non-cognitive skill profile 602, and repeat the process described above, including determining a new non-cognitive skill score and a prediction for college success.

If the update module 510 determines that the user has completed a first semester of college, the query module will present the user with a series of questions directed to the following “Continuing in College Non-Cognitive Constructs:
1. Continuing in College Non-Cognitive Constructs
   a. Interpersonal
      i. Support System
      ii. Communication Skills
      iii. Emotional Intelligence
      iv. Sense of Belonging

As with the user's first experience, for each construct, the user is presented with a series of questions addressing the particular construct, and the user is prompted to answer each question on a scale generally reflecting the range from Strongly Agree to Strongly Disagree. The answers can be textual as in the “agree or disagree” example or numeric, where, for example, 1 represents Strongly Disagree and 5 represents Strongly Agree. The update module 510 will update the user's non-cognitive skill profile 602, and repeat the process described above, including determining a new non-cognitive skill score and a prediction for college success.

The update module 510 may prompt the user to access the system following each completed semester of college for an updated evaluation, score and prediction. In particular, users will be prompted to access the system following successful completion of a college curriculum and the update module 510 update the user skill profile and add it to the successful college user non-cognitive skill profiles 604.

Processing continues at operation S480, where AI/machine learning module 512 continuously analyzes past and present user response, weighting, scoring, and prediction information, as well as data reflecting user success (or not) in college curricula. Based on this analysis, AI/machine learning module 512 makes automatic updates to weighting, scoring and prediction algorithms, as well as recommended non-cognitive skill improvement activities, to improve the system's prediction and recommendation accuracies. In a preferred embodiment, the machine learning algorithms are specifically and explicitly tuned to continuously search for and identify potential biases in the system as initiated, and then to adjust the inquiries and answer options, as well as the weighting, scoring and prediction algorithms, optionally with little or no human intervention, in order to reduce and potentially eliminate such biases. It is recognized that any particular rule change made according to this machine-learning process might have no effect, might increase a bias, and/or introduce another bias, but the machine learning algorithms will identify such result, and make further adjustments accordingly. The ability of AI/machine learning to analyze and identify patterns in massive data sets enables the system to iteratively arrive at sets of questions and answers, and weighting, scoring and prediction algorithms that have far fewer biases, if any, compared to existing student performance/success prediction systems.

It will be appreciated by those skilled in the art that changes could be made to the preferred embodiments described above without departing from the inventive concept thereof. It is understood, therefore, that this invention is not limited to the particular embodiments disclosed, but it is intended to cover modifications within the spirit and scope of the present invention as outlined in the present disclosure and defined according to the broadest reasonable reading of the claims that follow, read in light of the present specification.

1. A method comprising:
prompting a user to answer a series of questions directed to non-cognitive skills; storing said user's responses to said series of questions in a user skill profile data set including information indicative of a plurality of non-cognitive skill parameter values respectively corresponding to said user's likelihood of successfully completing a college curriculum;
assigning weighted values to each of said plurality of non-cognitive skill parameter values;
using said user skill profile data set and said weighted values to assign a weighted score to said user's skill profile data set; using a plurality of college graduate and college dropout skill profile data sets to make a prediction reflective of said user's likelihood of successfully completing said college curriculum;
recommending, by machine logic-based rules, to said user one or more non-cognitive skill improvement activities based on said user's weighted score.

2. The method of claim 1, further comprising:
after a predetermined amount of time, or after a user has completed said one or more non-cognitive skill improvement activities, prompting said user to answer said series of questions directed to non-cognitive skills, or prompting said user to answer a second series of questions directed to non-cognitive skills, and calculating an updated prediction reflective of said user's likelihood of successfully completing said college curriculum.

3. The method of claim 1, further comprising:
after said user has completed a college curriculum, updating said user skill profile data set to reflect whether said user successfully completed said college curriculum and adding said updated user skill profile data set to said plurality of college graduate and college dropout skill profile data sets.

4. The method of claim 1, further comprising using machine learning to improve assignment of scores, weighting, and predictions based on new data correlating college graduate and college dropout skill profile data.

5. A computer program product comprising:
a machine-readable storage device; and
computer code stored on the machine-readable storage device, with the computer code including instructions for causing a processor(s) set to perform operations including the following:
prompting a first user to answer a series of questions directed to a plurality of non-cognitive skills respectively corresponding to said user's likelihood of successfully completing a college curriculum storing said first user's answers to said series of questions in a first user skill profile data set;
assigning a weight to each said non-cognitive skills, and assigning a score to said first user's skill profile data set, and calculating a prediction of said first user's likelihood of success in successfully completing college based on said first user's weighted and scored skill profile data set; including said information indicative of a plurality of first user skill parameter values respectively corresponding to a first user's competency with respect to a physical activity related skill parameter, and
recommending, by machine logic-based rules, to said first user one or more non-cognitive skill improvement activities based on said user's weighted score.

6. The computer program product of claim 5 wherein the computer code further includes instructions for causing the processor(s) set to perform the following operations:
after a predetermined amount of time, or after a user has completed said one or more non-cognitive skill improvement activities, prompting said user to answer said series of questions directed to non-cognitive skills, or prompting said user to answer a second series of questions directed to non-cognitive skills, and calculating an updated prediction reflective of said user's likelihood of successfully completing said college curriculum.

7. The computer program product of claim 5 wherein the computer code further includes instructions for causing the processor(s) set to perform the following operations:
after said user has completed a college curriculum, updating said user skill profile data set to reflect whether said user successfully completed said college curriculum and adding said updated user skill profile data set to said plurality of college graduate and college dropout skill profile data sets.

8. The computer program product of claim 5 wherein the computer code further includes instructions for causing the processor(s) set to perform the following operations:
using machine learning to improve assignment of scores, weighting, and predictions based on new data correlating college graduate and college dropout skill profile data and outcomes.

9. A computer system comprising:
a processor(s) set;
a machine-readable storage device; and
computer code stored on the machine readable storage device, with the computer code including instructions for causing the processor(s) set to perform operations including the following:
prompting a user to answer a series of questions directed to non-cognitive skills; storing said user's responses to said series of questions in a user skill profile data set including information indicative of a plurality of non-cognitive skill parameter values respectively corresponding to said user's likelihood of successfully completing a college curriculum;
assigning weighted values to each of said plurality of non-cognitive skill parameter values;
using said user skill profile data set and said weighted values to assign a weighted score to said user's skill profile data set; using a plurality of college graduate and college dropout skill profile data sets to make a prediction reflective of said user's likelihood of successfully completing said college curriculum;
recommending, by machine logic-based rules, to said user one or more non-cognitive skill improvement activities based on said user's weighted score.

10. The computer system of claim 9 wherein the computer code further includes instructions for causing the processor(s) set to perform the following operations:
after a predetermined amount of time, or after a user has completed said one or more non-cognitive skill improvement activities, prompting said user to answer said series of questions directed to non-cognitive skills, or prompting said user to answer a second series of questions directed to non-cognitive skills, and calculating an updated prediction reflective of said user's likelihood of successfully completing said college curriculum.

11. The computer system of claim 9 wherein the computer code further includes instructions for causing the processor(s) set to perform the following operations:
after said user has completed a college curriculum, updating said user skill profile data set to reflect whether said user successfully completed said college curriculum and adding said updated user skill profile data set to said plurality of college graduate and college dropout skill profile data sets.

12. The computer system of claim 9 wherein the computer code further includes instructions for causing the processor(s) set to perform the following operations:
using machine learning to improve assignment of scores, weighting, and predictions based on new data correlating college graduate and college dropout skill profile data.

13. The method of claim 1, further comprising:
using machine-learning logic-based rules to identify patterns of bias and make changes to the weighting, scoring, and/or prediction algorithms directed to reducing said patterns of bias.

14. The computer program product of claim 5 wherein the computer code further includes instructions for causing the processor(s) set to perform the following operations:
using machine-learning logic-based rules to identify patterns of bias and make changes to the weighting, scoring, and/or prediction algorithms directed to reducing said patterns of bias.

15. The computer system of claim 9 wherein the computer code further includes instructions for causing the processor(s) set to perform the following operations:
using machine-learning logic-based rules to identify patterns of bias and make changes to the weighting, scoring, and/or prediction algorithms directed to reducing said patterns of bias.
